(19) United States
(12) Patent Application Publication
(10) Pub. No.: US 2015/0342831 A1
(43) Pub. Date: Dec. 3, 2015

(54) TWIST TOP 2000

(71) Applicant: ANTONIO JARVIS WESLEY, Las Vegas, NV (US)

(72) Inventor: ANTONIO JARVIS WESLEY, Las Vegas, NV (US)

(21) Appl. No.: 14/292,769

(22) Filed: May 30, 2014

(51) Int. Cl. A61J 9/00

(52) U.S. Cl. CPC A61J 9/00

(57) ABSTRACT

I Have invented a new baby bottle. That has been designed to hold two liquids inside one 8½ oz. bottle. This bottle can also discharge each liquid from the same op or nipple separately, without mixing the two sides. What I have done was taken the old conventional baby bottle, and reconstructed a new improved design. “THE TWIST TOP 2000”. This new baby bottle will not only hold and dispense two liquids. It has a new sleaker design. We have installed infant holding handles. These handles are used to equal out the bottle weight, and small enough for a infant to grab and hold at an earlier stage. Instead of making two bottles to hold each liquid, Now one bottle can do the job. This means less time to prepare and more time to be aware of your child or infant. No more digging around to find that other bottle. No more carring around that extra weight. “THE TWIST TOP 2000” BABY BOTTLE OF THE FUTURE, Has improved the response time, and broken barriers in the field of child care and development.

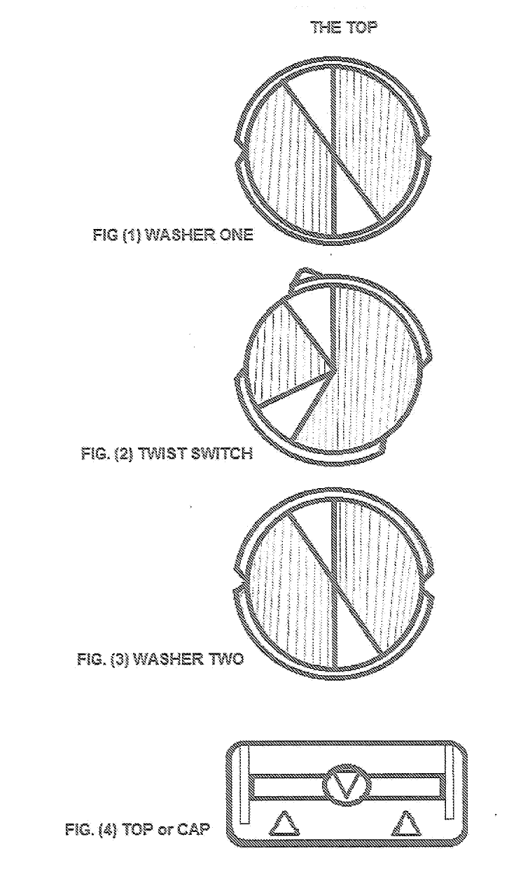

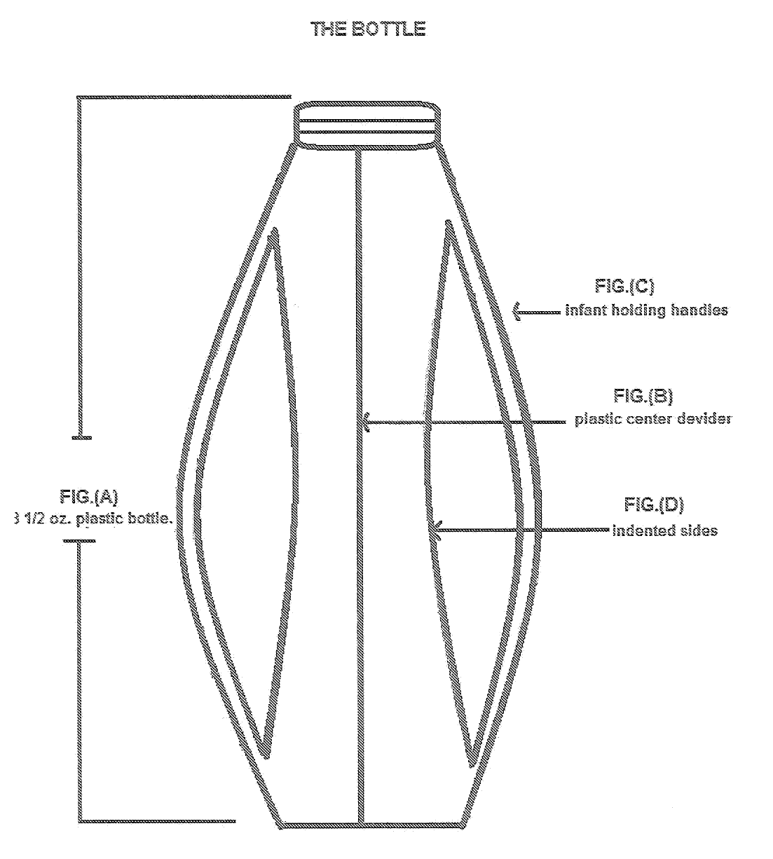

### BRIEF DESCRIPTIONS

### Pages (1) “The Top”

FIG. (1) This is the first of two washers. This washer is a thin piece of plastic, with two triangulal shaped holes centered diagonally across from one another. This washer will help stop the liquids from joining together or leaking.

FIG. (2) The Twist Switch. This switch is made of a thin piece of plastic, with two triangular shaped holes centered diagonally across from one another. There is also a lever along the sides of this plastic piece, used to seperate the two liquids.

FIG. (3) This is the second washer. This washer is made of a thin plastic with two triangular shaped holes centered diagonally across from each other, also used to help stop any leakage.

FIG. (4) The Top or Cap. This cap holds all of the components in place. Two pins are centered across from each other to keep the parts stable and secure. This cap is also made of plastic.

### Page: (2) “The Bottle”

FIG. (A) The Bottle. This Bottle is made of a microwavable plastic.

FIG. (B) This bottle has a think plastic devider down the center to seperate the two liquids.

FIG. (C) I have made infant holding handles, these handles are also made of microwavable plastic. And a lot easier for small children to hold.

FIG. (D) I have made this bottle with indented sides. To give the infant or small child a way to grab and hold this bottle at an earlier stage.

### BRIEF SUMMARY OF INVENTION

This new invention has improved on all aspects of the old conventional baby bottles. We have added a more convenient design, to help the parent in feeding and also the infant or small child in handling this new invention. It has become more easier for a parent to fix one baby bottle, with two liquids, than to fix two baby bottles with one liquid. This special designed baby bottle has a think plastic devider down the center to seperate the two liquids. We also installed infant holding handles, and indented the sides, to give a small child or infant a chance to hold this bottle at an earlier stage. This means less time to prepare, and more time to be aware of your child. This new invention has improved the response time in child care development.

What I claim as my new invention is:

1.(a) I claim a two sided baby bottle, that can hold two liquids inside one bottle and release one individual liquid at a time, from the same top or spout.

2.(b) The Twist Switch Mechanism. This switch has four parts, used to seperate and release one liquid at a time. This mechanism will allow you to choose the liquid preferred at the time of use.

3.(c) This new baby bottle design has a thin layer of plastic down the center of the bottle to separate the two liquids. It also has infant holding handles, with indented sides. This gives the baby bottle a more sleek design.
